(19) United States
(12) Patent Application Publication
(10) Pub. No.: US 2013/0227396 A1
(43) Pub. Date: Aug. 29, 2013

(54) EDITING CONTENT OF A PRIMARY DOCUMENT AND RELATED FILES

(71) Applicants: Kirupa Chinnathambi, Redmond, WA (US); Christian Schormann, Seattle, WA (US); Yeoh Lin Li Lena, Issaquah, WA (US); Unnikrishnan Ravindranathan, Issapuah, WA (US); Charles Yvon Bissonnette, Redmond, WA (US); Erik Andrew Saltwell, Seattle, WA (US)

(72) Inventors: Kirupa Chinnathambi, Redmond, WA (US); Christian Schormann, Seattle, WA (US); Yeoh Lin Li Lena, Issaquah, WA (US); Unnikrishnan Ravindranathan, Issapuah, WA (US); Charles Yvon Bissonnette, Redmond, WA (US); Erik Andrew Saltwell, Seattle, WA (US)

(73) Assignee: Microsoft Corporation, Redmond, WA (US)

(21) Appl. No.: 13/404,327

(22) Filed: Feb. 24, 2012

(51) Int. Cl. G06F 17/00

(52) U.S. Cl. 715/235; 715/234

(57) ABSTRACT

A method includes providing a Web development tool for developing an application that includes a primary document and a plurality of related files. A user interface for controlling the Web development tool is generated. The method includes generating as part of the user interface a code editor panel, wherein the code editor panel includes a primary editor sub-panel for editing content of the primary document and a secondary editor sub-panel for editing content of the related files.

### BACKGROUND

Web-based content can be provided in HyperText Markup Language (HTML) pages, style sheets, images, scripts, etc. Some Web page development environments offer the possibility to provide different views for the HTML document edited and displayed simultaneously. This capability is commonly referred to as “Split View”. Such environments offer a code (or text) view and a design (or graphical) view. For example, an editor can present HTML code in a code view and the output of executing the HTML code in a corresponding what-you-see-is-what-you-get (WYSIWIG) design view (e.g., representing what will be presented to an end-user who accesses the Web page). Accordingly, a developer can make changes in either the code view or the design view to alter Web page functionality.

HTML documents, especially those that define applications, are typically composed of many external files. Instead of having one large monolithic document that incorporates the full functionality of an application, the functionality is typically broken up and divided across various other HTML, Cascading Style Sheets (CSS), and JavaScript files.

While this decentralization has the benefit of breaking up the applications into re-usable modules, it has the disadvantage of making it difficult to actually build applications. It definitely makes it difficult for a person wishing to style or modify an existing application because the person does not know which files contribute to the overall document. In addition, having to constantly switch files reduces the productivity of the application developer.

### SUMMARY

One embodiment provides a “Related Files” feature that provides direct access to all of the files that make up a particular document or application. One embodiment provides not only the ability to modify the source of the primary document (i.e., the document that references the related files), but also the ability to provide categorized access to the related HTML, CSS, and JavaScript files that the primary document depends on. One embodiment of this feature allows a user to edit both the primary document as well as the secondary/related document at the same time, and provides good synchronization between the related files view and the visual design tools.

One embodiment is directed to a method that includes providing a Web development tool for developing an application that includes a primary document and a plurality of related files. A user interface for controlling the Web development tool is generated. The method includes generating as part of the user interface a code editor panel, wherein the code editor panel includes a primary editor sub-panel for editing content of the primary document and a secondary editor sub-panel for editing content of the related files.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated, as they become better understood by reference to the following detailed description. The elements of the drawings are not necessarily to scale relative to each other. Like reference numerals designate corresponding similar parts.

FIG. 1 is a block diagram illustrating a web development tool according to one embodiment.

FIG. 2 is a block diagram illustrating a computing device/environment suitable for implementing aspects of the web development tool illustrated in FIG. 1 according to one embodiment.

FIG. 3 is a functional block diagram illustrating a web development tool according to one embodiment.

FIG. 4 is a diagram illustrating a code editor panel according to one embodiment.

FIG. 5 is a diagram illustrating an expanded view of the secondary editor sub-panel shown in FIG. 4 according to one embodiment.

FIG. 6 is a diagram illustrating a user interface for the Web development tool shown in FIG. 3 according to one embodiment.

FIG. 7 is a diagram illustrating the appearance of the user interface shown in FIG. 6 after a user selection has been made according to one embodiment.

FIG. 8 is a diagram illustrating a Styles pane of the user interface shown in FIG. 6 according to one embodiment.

FIG. 9 is a diagram illustrating the appearance of the code editor panel after the selection shown in FIG. 8 has been made according to one embodiment.

FIG. 10 is a diagram illustrating a CSS properties panel of the user interface shown in FIG. 6 according to one embodiment.

FIG. 11 is a diagram illustrating the appearance of the code editor panel after the modification shown in FIG. 10 has been made according to one embodiment.

FIG. 12 is a flow diagram illustrating a method for providing control of a Web development tool according to one embodiment.

### DETAILED DESCRIPTION

In the following Detailed Description, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that features of the various exemplary embodiments described herein may be combined with each other, unless specifically noted otherwise.

One embodiment provides a “Related Files” feature that provides direct access to all of the files that make up a particular document or application. One embodiment provides not only the ability to modify the source of the primary document (i.e., the document that references the related files), but also the ability to provide categorized access to the related HTML, CSS, and JavaScript files that the primary document depends on. One embodiment of this feature allows a user to edit both the primary document as well as the secondary/related document at the same time, and provides good synchronization between the related files view and the visual design tools. In one embodiment, modifications made in the visual tools will highlight the appropriate markup in the related files view. Overall, embodiments of this solution are easier to use than other existing solutions, and make designers/developers more productive when building complex documents, such as those that can be found in Windows 8 applications.

Embodiments provided herein make working with documents composed of many other documents easier, while retaining the ability to simultaneously edit the primary document as well as use the visual tools. One embodiment provides a user with the ability to edit both the primary document as well as a document related to the primary document, and the ability to visualize the markup that is being modified in the primary document or related document as a result of changes to the visual tools. These features will be described in further detail below, following the description of a web development tool suitable for implementing these and other features.

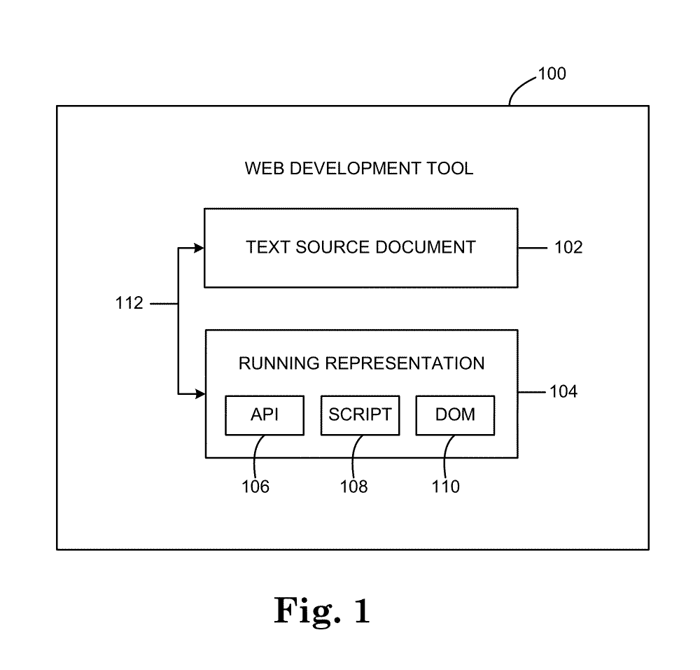

FIG. 1 is a block diagram illustrating one embodiment of a web development tool 100. Web development tool 100 includes a text source document 102 and a running representation 104 of the text source document. In one embodiment, the text source document 102 is opened in a web page source code editor. In other embodiments, text source document 102 or portions of the text source document 102 are displayed in a web page source code viewer. In one embodiment, the running representation 104 of text source document 102 is provided by a browser. In other embodiments, the running representation 104 of text source document 102 is provided by a designer, a property pane, or other suitable visualization of the running representation of the text source document.

A modification to the web page source code is applied to the running page instance of the web page as represented by running representation 104 to dynamically update the running page instance to include the modification to the web page source code. Likewise, a modification to a Document Object Model (DOM) element in the running page instance of the web page is applied to the web page source code to dynamically update the web page source code to include the modification to the DOM element. In this way, a web page developer may modify DOM elements in a running instance of the web page in a browser and/or modify the web page source code and the modifications are dynamically applied to the web page source code and/or the running instance of the web page, respectively.

Web page source code of text source document 102 is linked, via link 112, to associated DOM 110 elements in a running page instance of the web page as represented by running representation 104. Therefore, by selecting or highlighting a DOM element within running representation 104, the web page text associated with the selected or highlighted DOM element is selected or highlighted within text source document 102. Likewise, by selecting or highlighting a portion of the web page text within text source document 102, the DOM element or elements associated with the selected or highlighted portion of the web page text is selected or highlighted within running representation 104. In this way, a web page developer can instantly match DOM elements as they are represented in a running instance of the web page with the web page text source code that defines the DOM elements.

In one embodiment, text source document 102 is opened in a source code editor, which includes any suitable text editor suitable for opening, creating, editing, and saving web page text source documents. In one embodiment, the web page text source documents that can be edited by the source code editor include markup text, such as HyperText Markup Language (HTML), Cascading Style Sheets (CSS), Extensible Markup Language (XML), and/or Extensible HyperText Markup Language (XHTML). The web page text source documents may also include JavaScript or JScript. As used herein, “JS” is used to refer to both JavaScript and JScript. In other embodiments, the source code editor is suitable for opening, creating, editing, and saving web page text source documents including other suitable web page markup text and scripting languages. In one embodiment, the source code editor supports multiple instances of web page text source documents such that related or linked web page text source documents may be simultaneously opened within the source code editor.

In one embodiment, running representation 104 is a web browser suitable for representing a DOM 110. In one embodiment, the browser is a World Wide Web Consortium (W3C) compliant web browser. In one embodiment, the browser provides a browser agnostic representation of a DOM 110 such that the representation of the DOM 110 does not depend on any particular browser, such as Internet Explorer, FireFox, Chrome, Safari, or Opera. In another embodiment, the browser is selected such that the representation of the DOM 110 is based on the selected browser. The browser may include an option for the user to select a particular browser, such as Internet Explorer, FireFox, Chrome, Safari, or Opera, on which to base the representation of the DOM 110. In one embodiment, the browser supports multiple instances of DOMs such that related or linked web pages may be simultaneously running within the browser. Running representation 104 may also include running script 108 and an Application Programming Interface (API) 106. Script 108 and API 106 may modify, delete, and/or insert DOM elements in DOM 110 within running representation 104.

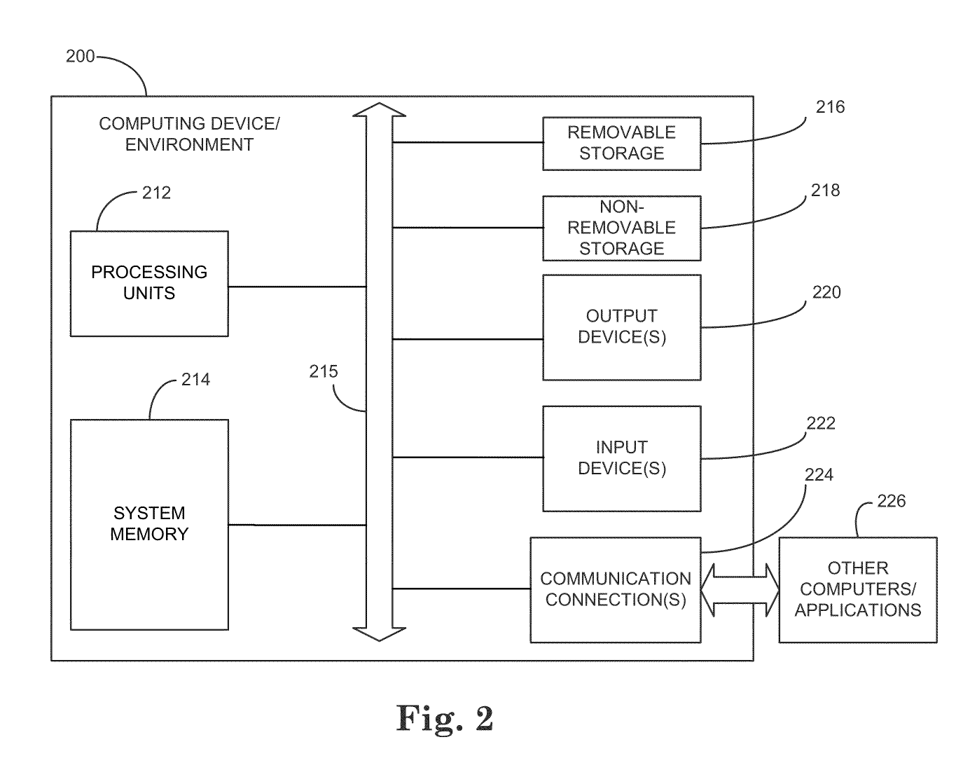

FIG. 2 is a block diagram illustrating one embodiment of a computing device/environment 200 suitable for implementing aspects of web development tool 100 previously described and illustrated with reference to FIG. 1. Computing device/environment 200 includes one or more processing units 212 and system memory 214. Depending on the exact configuration and type of computing device/environment 200, memory 214 may be volatile (such as RAM), non-volatile (such as ROM, flash memory, etc.), or some combination of the two.

Computing device/environment 200 may also have additional or different features/functionality and additional or different hardware and software. For example, computing device/environment 200 may also include additional storage (removable and/or non-removable) including, but not limited to, magnetic or optical disks or tape. Such additional storage is illustrated in FIG. 2 by removable storage 216 and non-removable storage 218. Computer storage media includes volatile and nonvolatile, removable and non-removable media implemented in any suitable method or technology for storage of information such as computer readable instructions, data structures, program modules or other data. Memory 214, removable storage 216, and non-removable storage 218 are all examples of computer storage media (e.g., computer-readable storage media storing computer-executable instructions that when executed by at least one processor cause the at least one processor to perform a method). Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by computing device/environment 200. Any such computer storage media may be part of computing device/environment 200.

The various elements of computing device/environment 200 are communicatively coupled together via one or more communication links 215. Computing device/environment 200 also includes one or more communication connections 224, such as network connections, that allow computing device/environment 200 to communicate with other computers/applications 226. Computing device/environment 200 may also include input device(s) 222, such as a keyboard, a pointing device (e.g., mouse), a pen, a voice input device, a touch input device, etc. Computing device/environment 200 may also include output device(s) 220, such as a display, speakers, a printer, etc.

FIG. 2 and the above discussion are intended to provide a brief general description of a suitable computing environment in which one or more embodiments may be implemented, and is not intended to suggest any limitation as to the scope of use or functionality of the embodiments.

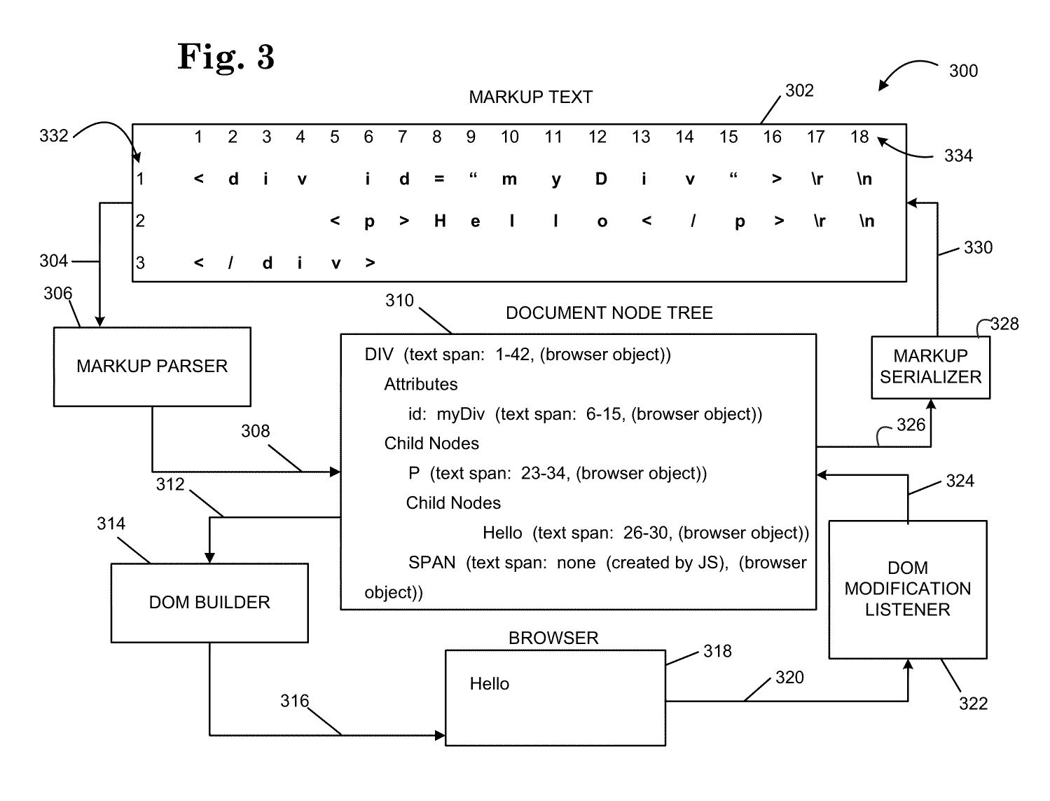

FIG. 3 is a functional block diagram illustrating one embodiment of a web development tool 300. In one embodiment, web development tool 300 provides web development tool 100 previously described and illustrated with reference to FIG. 1. Web development tool 300 includes markup text 302, a markup parser 306, a document node tree 310, a DOM builder 314, a browser 318, a DOM modification listener 322, and a markup serializer 328. Markup text 302 is input to markup parser 306 as indicated at 304. Markup parser 306 outputs document node tree 310 as indicated at 308. Document node tree 310 is input to DOM builder 314 as indicated at 312. DOM builder 314 outputs a DOM to browser 318 as indicated at 316. DOM modification listener 322 tracks changes to the DOM elements within browser 318 as indicated at 320. DOM modification listener 322 outputs change information to document node tree 310 as indicated at 324. Markup serializer 328 receives change information from document node tree 310 as indicated at 326. Markup serializer 328 updates markup text 302 with serialized change information as indicated at 330.

Markup text 302 includes HTML, CSS, XML, XHTML, and/or other suitable markup text. In one embodiment, the source document including markup text 302 is opened in a source code editor. In other embodiments, web development tool 300 accesses the source document including markup text 302 without opening the source document in a source code editor. Markup text 302 defines any suitable number of objects for providing a web page. In the example illustrated in FIG. 3, markup text 302 includes HTML. The example HTML defines one object for providing a DOM element including the text “Hello”.

Due to the textual nature of markup text 302, each character of markup text 302 has a corresponding line number as indicated at 332 and a corresponding relative character number for the line as indicated at 334. For example, the character “H” in markup text 302 is at line 2, character 8. Each character of markup text 302 also has a character number that indicates the position of the character relative to the beginning of markup text 302. For example, the character “H” in markup text 302 has the character number of 26 since it is the 26^{th} character in markup text 302. Thus, each character within markup text 302 can be located based on either a line number and position within the line or based on the character number that indicates the position of the character relative to the beginning of markup text 302. Likewise, a series of characters within markup text 302 can be located based on a range of line numbers and positions within the lines or based on a range of character numbers. As used herein, these ranges of line numbers and positions within the lines or ranges of character numbers are referred to as “text offsets.”

Markup text 302 is parsed by markup parser 306 to construct document node tree 310. In one embodiment, markup parser 306 is located on the same computing device/environment as the source code editor. In another embodiment, markup parser 306 is located on a different computing device/environment from the source code editor. Markup parser 306 includes an HTML parser, a CSS parser, an XML parser, an XHTML parser, and/or other suitable markup text parsers. In one embodiment, markup parser 306 is W3C compliant. In another embodiment, markup parser 306 is based on the parser associated with a particular browser, such as Internet Explorer, FireFox, Chrome, Safari, or Opera. In other embodiments, markup parser 306 is a hybrid parser that includes the basic implementation of the parser associated with a particular browser with alterations in the parsing implementation based on knowledge of the particular browser runtime execution and/or parse behavior.

Markup parser 306 includes the source document details from markup text 302, which are relevant to web pages, in document node tree 310. In addition to HTML objects and CSS objects, markup parser 306 includes other details from markup text 302, such as doctype and in-source comments that might be interpreted by browsers. Markup parser 306 also includes text offsets in document node tree 310 indicating the location of the source document details in markup text 302. The text offsets map each node of document node tree 310 to the markup text associated with the node. In this way, a link between document node tree 310 and markup text 302 is maintained during the parsing process. This differentiates markup parser 306 from conventional parsers integrated within browsers, which often discard or transform source document details during rendering for performance reasons and do not maintain any link between the source document and the rendered document.

In the example illustrated in FIG. 3, document node tree 310 uses ranges of character numbers as text offsets. For example, document node tree 310 includes the text offset “text span: 1-42” for the parent node “DIV”, which indicates the location of the object “DIV” in markup text 302. Likewise, document node tree 310 includes the text offset “text span: 6-15” for the attribute “id”, the text offset “text span: 23-34 for the child node “P”, and the text offset “text span: 26-30” for the child node “Hello”. Thus, by including the text offsets for each object within document node tree 310, each object within document node tree 310 is mapped to the source document markup text that is associated with the object.

DOM builder 314 constructs a DOM and a view node tree that represents the DOM from document node tree 310. DOM builder 314 maps each node of the view node tree to a corresponding node of the document node tree such that each element of the DOM is linked to the associated object in document node tree 310 and thereby to the source document markup text that is associated with the object. In one embodiment, DOM builder 314 injects event listeners into the DOM for tracking modifications to the DOM.

In one embodiment, DOM builder 314 constructs JS elements. Once executing, the JS elements may construct and/or modify DOM elements and corresponding nodes within the view node tree, which may not have corresponding nodes within document node tree 310.

In one embodiment, DOM builder 314 constructs a browser agnostic DOM that does not depend on any particular browser, such as Internet Explorer, FireFox, Chrome, Safari, or Opera. In another embodiment, DOM builder 314 is selected such that the DOM is constructed based on a selected browser. DOM builder 314 may include an option for the user to select a particular browser, such as Internet Explorer, FireFox, Chrome, Safari, or Opera, on which to base the construction of the DOM. The constructed DOM is represented by browser 318. In one embodiment, browser 318 is a W3C compliant browser. In the example illustrated in FIG. 3, browser 318 displays a DOM element including the text “Hello” as defined by markup text 302.

The view node tree and document node tree 310 link the DOM elements within browser 318 to markup text 302. For example, by selecting or highlighting “Hello” within browser 318, the associated markup text within markup text 302 is selected or highlighted. Conversely, by selecting or highlighting “<p>Hello</p>” within markup text 302, the associated DOM element “Hello” in browser 318 is selected or highlighted.

DOM modification listener 322 tracks changes to DOM elements, such as DOM mutations, within browser 318. In one embodiment, DOM modification listener 322 tracks changes to DOM elements due to API 106 and/or script 108 (FIG. 1). In one embodiment, DOM modification listener 322 generates a change record for each change to a DOM element. Each change record identifies the modified DOM element by node of the view node tree and the change applied to the node. A change record may also identify a DOM element that has been deleted or inserted. DOM modification listener 322 then updates the corresponding node in document node tree 310 based on the change record.

In one embodiment, changes can be made to DOM elements via document node tree 310 by a user modifying element attributes and/or style properties via a properties panel or other suitable mechanism. In this embodiment, the properties panel generates a change record for each change to an element. Each change record identifies the element to modify by node of the document node tree and the change to apply to the node. The change record updates the node in document node tree 310 based on the change record. DOM builder 314 then updates the DOM and the view node tree that represents the DOM based on the updated document node tree 310 such that the representation of the DOM in browser 318 includes the modification.

Markup serializer 328 serializes change information in document node tree 310 for updating markup text 302. Markup serializer 328 formats the changes to document node tree 310 (e.g., due to change records from DOM modification listener 322 or from the properties panel) to include the information needed to modify markup text 302 to match the updated document node tree 310. In one embodiment, the information provided by markup serializer 328 includes the text offsets indicating the location where the change is to be made in markup text 302 and the new value to place at the indicated location. In one embodiment, markup serializer 328 combines change information for a plurality of changes to document node tree 310 into a single serialized data file to update markup text 302 in a batch process in response to a user action. In another embodiment, markup serializer 328 may update markup text 302 in a batch process including multiple data files.

Changes can also be made to markup text 302 within a source code editor. In one embodiment, after a change to markup text 302, markup parser 306 performs a partial parsing of markup text 302 to update document node tree 310. In another embodiment, after a change to markup text 302, markup parser 306 performs a complete parsing of markup text 302 to update document node tree 310. DOM builder 314 then updates the DOM and the view node tree that represents the DOM such that the change to markup text 302 is reflected in browser 318.

When it comes to HTML applications, similar to web pages today, the end result is often a composite involving many other files. Some of the files will be assets like images that a user can simply view. Some of the files will be editable HTML, CSS, and JavaScript files. In one embodiment, Web development tool 300 provides users with the ability to easily create, modify, and style their applications even if the markup they are touching is defined in a different document. One of the features in Web development tool 300 that helps users navigate this fragmented world is referred to herein as a related files feature.

From a user interface (UI) point of view, the related files feature enhances the split view feature provided by Web development tool 300. In the split view, both a code view and a design view are open at the same time. The split view allows a user to see the markup highlighted for an element that the user has selected in the artboard or in the object tree, or if the user explicitly chooses a “View Code” command via a context menu. The related files feature enhances the split view feature by allowing a user to view the markup for all related documents—not just the markup for the main document that the user currently has open.

The related files feature is beneficial for a number of reasons. First, HTML designers feel more comfortable when they can see the markup that is being generated or modified as a result of visual changes. Second, because Web development tool 300 seamlessly allows one to edit inside and outside fragments in one embodiment, not having the appropriate markup from the external document highlighted may make the split view feel incomplete or unfinished. Third, some users feel more productive writing markup manually rather than using visual/design tools. By providing these users with the ability to easily jump between the visual tools and the markup, the system gives them the ability to use whichever view they are comfortable with without abandoning the design surface in favor of only the markup.

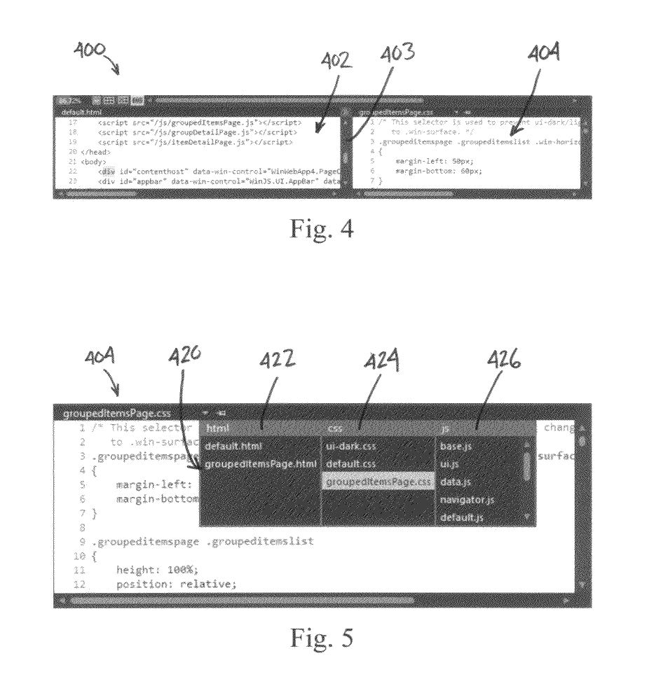

FIG. 4 is a diagram illustrating a code editor panel 400 according to one embodiment. The code editor panel 400 is used to implement the related files feature according to one embodiment. The code editor panel 400 according to one embodiment is visible when a user starts building an application, such as a Windows 8 application. In one embodiment, the related files feature is a part of the visual design experience where users can manipulate their application using the design surface or the properties inspectors without having to go into a code-only or design-only mode.

Code editor panel 400 includes a primary editor sub-panel 402 and a secondary editor sub-panel 404. The primary editor sub-panel 402 displays the markup for the primary document. The secondary editor sub-panel displays the related markup and code files that the primary document uses. From the related files view, a user can select other related files that the user would like to see, including related HTML files, related CSS files, and related JavaScript (JS) files. Sub-panels 402 and 404 according to one embodiment are positioned immediately adjacent to each other, and have the same height (in a vertical direction), but different widths (in a horizontal direction). In one embodiment, sub-panels 402 and 404 have a default size in which sub-panel 402 is larger than sub-panel 404 and occupies about 60% of the total area of the panel 400, while sub-panel 404 occupies about 40% of the total area of the panel 400. Sub-panels 402 and 404 are configured to be resized by a user. In one embodiment, the border 403 between the sub-panels 402 and 404 acts as a resize grip that allows a user to adjust the sizes of sub-panels 402 and 404.

FIG. 5 is a diagram illustrating an expanded view of the secondary editor sub-panel 404 shown in FIG. 4 according to one embodiment. As shown in FIG. 5, a user has selected to view related files, and a sub-panel 420 is displayed in response. The sub-panel 420 shows a categorized view of the related files. The related files include a first list 422 of related HTML files, a second list 424 of related CSS files 424, and a third list 426 of related JavaScript files. A user may select any of the related files in the sub-panel 420, and the content for the selected file will be displayed in the secondary editor sub-panel 404.

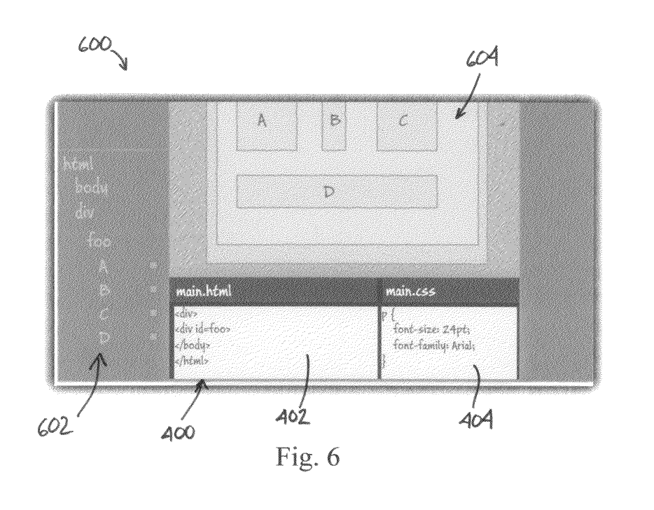

FIG. 6 is a diagram illustrating a user interface 600 for the Web development tool 300 shown in FIG. 3 according to one embodiment. User interface 600 includes a live DOM panel 602, an artboard panel 604, and code editor panel 400. In other embodiments, user interface 600 includes other panels and features, and the content of user interface 600 varies based on selections made by a user. User interface 600 according to one embodiment provides users with the ability to do the following: See the markup for elements highlighted in the artboard panel 604; see the markup for elements highlighted in the live DOM panel 602; see the markup for rules selected in a Styles pane; see both an active HTML document's markup as well as related CSS, HTML, and JavaScript files in the code editor panel 400; resize the sub-panels 402 and 404; and close either or both of the sub-panels 402 and 404.

In one embodiment, when a user opens a document with user interface 600 and has nothing selected in the artboard panel 604, live DOM panel 602, styles panel, etc., the panel 400 will show the markup for the currently active HTML document in the sub-panel 402 with the sub-panel 404 grayed out. Since nothing has been selected, the default behavior according to one embodiment is to show the very top of the markup with nothing selected. If the user selects an element via the live DOM panel 602 or the artboard panel 604 that is declared inside the currently active document (main.html) shown in sub-panel 402, the corresponding line of code is highlighted in sub-panel 402. Sub-panel 404 will not show anything, again, because nothing CSS-related (or HTML-related or JavaScript related) was selected.

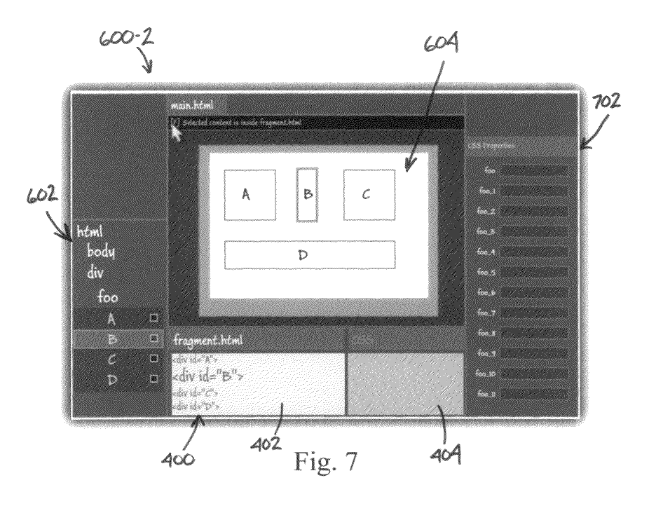

Assume that a user selects a fragment element, called “B”, which is declared in an external document called fragment.html. This selection may be triggered via the live DOM panel 602 or the artboard panel 604. The end result of this selection will be that the markup in sub-panel 402 corresponding to this selection will be highlighted, and the HTML header at the top of the sub-panel 402 will be changed from “main.html” to the file name from where this markup is coming from (e.g., “fragment.html”). FIG. 7 is a diagram illustrating the appearance of the user interface 600 shown in FIG. 6 after such a user selection has been made according to one embodiment. The appearance of the user interface shown in FIG. 7 is represented by reference numeral 600-2, and in addition to including the same elements as FIG. 6, user interface 600-2 also includes a CSS properties panel 702. While sub-panel 402 shows the contents of fragment.html, the design surface (e.g., artboard panel 604) shows main.html. The markup for all of these changes is displayed in the context of the main document the selection was initiated from. In one embodiment, the currently active document is not switched to fragment.html unless the user explicitly chooses to open that file and switch to it. As shown in FIG. 7, sub-panel 404 still appears blank and grayed out because nothing CSS-related (or HTML-related or JavaScript-related) was selected.

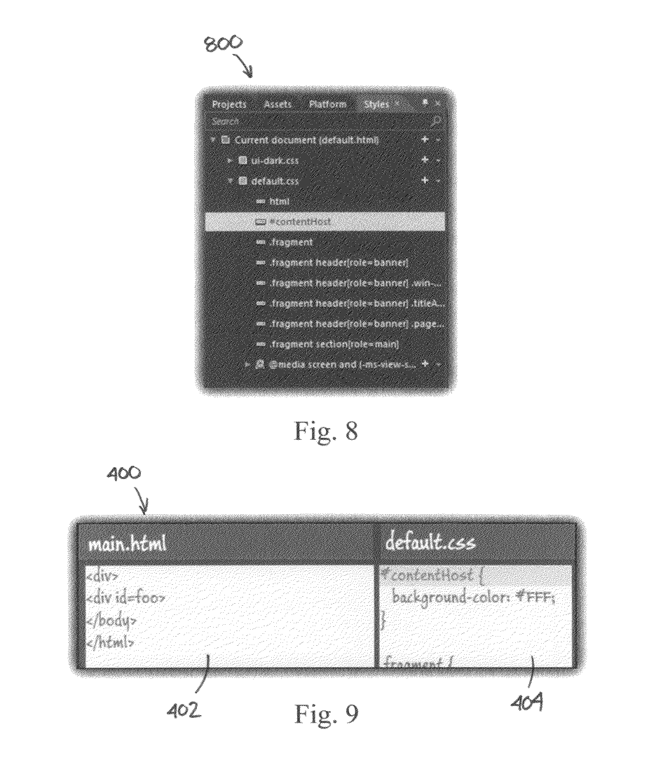

If a user multi-selects HTML elements via the artboard panel 604 or live DOM panel 602, the markup of the last item selected is highlighted in sub-panel 402. If a user selects a CSS rule via a Styles pane, the selected line is displayed in the sub-panel 404. Assume that a user selected a CSS rule with the selector “#contentHost” from the Styles pane. FIG. 8 is a diagram illustrating a Styles pane 800 of the user interface 600 shown in FIG. 6 according to one embodiment. As shown in FIG. 8, the user has selected “#contentHost” from the Styles pane 800. FIG. 9 is a diagram illustrating the appearance of the panel 400 after the selection shown in FIG. 8 has been made according to one embodiment. As shown in FIG. 9, the line where the contentHost rule starts has been highlighted in sub-panel 404, and the header in sub-panel 404 shows the name of the CSS file where this rule is defined (i.e., “default.css”). The sub-panel 402 does not have anything highlighted in FIG. 9, and whatever position the code in the HTML view was in earlier is still preserved.

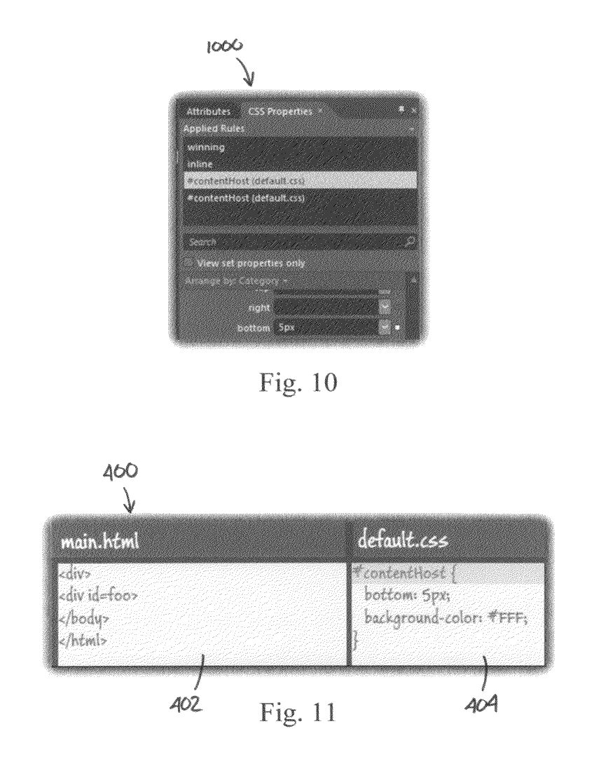

From a CSS Attributes panel in user interface 600, a user can select a winning entry. In one embodiment, when a user selects a winning entry, sub-panel 404 is empty and grayed out. If the user is in “winning mode” and gives focus to a value editor from the CSS properties panel, the appropriate CSS rule is highlighted in sub-panel 404. FIG. 10 is a diagram illustrating a CSS properties panel 1000 of the user interface 600 shown in FIG. 6 according to one embodiment. As shown in FIG. 10, a user is editing the “bottom” CSS property, and has entered “5px”. FIG. 11 is a diagram illustrating the appearance of the panel 400 after the modification shown in FIG. 10 has been made according to one embodiment. As shown in FIG. 11, the first line of the contentHost rule is highlighted in sub-panel 404, and the modified property (i.e., “bottom: 5px;”) is shown below the highlighted line.

In one embodiment, if a user selects Inline rule from the CSS attributes panel, sub-panel 404 will be grayed out. A user can easily switch over into the HTML view and see the inline rules instead.

In one embodiment, the content for sub-panels 402 and 404 are synchronized based on selections on the live DOM, artboard, CSS Properties panel, and Styles Panel, of the user interface 600. In one embodiment, synchronization between the sub-panel 402 and the artboard and live DOM is two-way. A selection in the sub-panel 402 will result in the appropriate content getting selected in the object tree and artboard. In one embodiment, for sub-panel 404, the synchronization is one-way. A selection inside the sub-panel 404 will not result in a different rule getting selected.

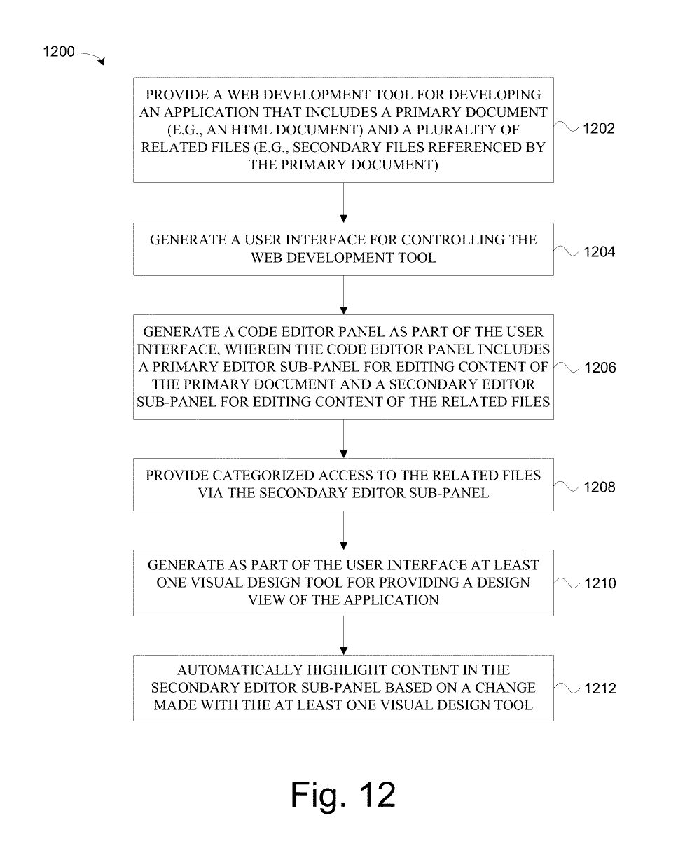

FIG. 12 is a flow diagram illustrating a method 1200 for providing control of a Web development tool according to one embodiment. At 1202, a Web development tool for developing an application that includes a primary document (e.g., an HTML document) and a plurality of related files (e.g., secondary files referenced by the primary document) is provided. At 1204, a user interface for controlling the Web development tool is generated. At 1206, a code editor panel is generated as part of the user interface, wherein the code editor panel includes a primary editor sub-panel for editing content of the primary document and a secondary editor sub-panel for editing content of the related files. At 1208, categorized access to the related files is provided via the secondary editor sub-panel. At 1210, at least one visual design tool is generated as part of the user interface for providing a design view of the application. At 1212, content in the secondary editor sub-panel is automatically highlighted based on a change made with the at least one visual design tool.

In one embodiment of method 1200, the generating a user interface and the generating as part of the user interface a code editor panel are performed by at least one processor. In one embodiment, the content of the primary document and the content of at least one of the related files in method 1200 are displayed at the same time by the code editor panel. The code editor panel according to one embodiment is configured to be used to edit the content of the primary document and the content of at least one of the related files at the same time. In one embodiment, the providing categorized access at 1208 includes displaying on the secondary editor sub-panel: (1) a first list of all Cascading Style Sheet (CSS) files related to the primary document; (2) a second list of all JavaScript files related to the primary document; and (3) a third list of all HTML files related to the primary document. In one form of this embodiment, selection of one of the files in the first list, second list, or third list causes content of the selected file to be displayed in the secondary editor sub-panel.

The techniques described herein are not limited to HTML and Web development. These techniques can be used when authoring applications for any platform that has a notion of related support files used by a main document. For example, in the xaml platform, the system could show resource dictionaries related to a main xaml file.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method comprising:
providing a Web development tool for developing an application that includes a primary document and a plurality of related files;
generating a user interface for controlling the Web development tool; and
generating as part of the user interface a code editor panel, wherein the code editor panel includes a primary editor sub-panel for editing content of the primary document and a secondary editor sub-panel for editing content of the related files.

2. The method of claim 1, wherein the generating a user interface and the generating as part of the user interface a code editor panel are performed by at least one processor.

3. The method of claim 1, wherein the content of the primary document and the content of at least one of the related files are displayed at the same time by the code editor panel.

4. The method of claim 1, wherein the code editor panel is configured to be used to edit the content of the primary document and the content of at least one of the related files at the same time.

5. The method of claim 1, wherein the primary document is an HTML document.

6. The method of claim 1, and further comprising:
providing categorized access to the related files via the secondary editor sub-panel.

7. The method of claim 6, and further comprising:
displaying on the secondary editor sub-panel a first list of all Cascading Style Sheet (CSS) files related to the primary document.

8. The method of claim 7, and further comprising:
displaying on the secondary editor sub-panel a second list of all JavaScript files related to the primary document.

9. The method of claim 8, and further comprising:
displaying on the secondary editor sub-panel a third list of all HTML files related to the primary document.

10. The method of claim 9, wherein selection of one of the files in the first list, second list, or third list causes content of the selected file to be displayed in the secondary editor sub-panel.

11. The method of claim 1, and further comprising:
generating as part of the user interface at least one visual design tool for providing a design view of the application.

12. The method of claim 11, and further comprising:
automatically highlighting content in the secondary editor sub-panel based on a change made with the at least one visual design tool.

13. A computer-readable storage medium storing computer-executable instructions that when executed by at least one processor cause the at least one processor to perform a method within a computing system, the method comprising:
providing a Web development tool for developing an application that includes a primary document and a plurality of secondary files referenced by the primary document;
generating a user interface for controlling the Web development tool; and
generating as part of the user interface a code editor panel, wherein the code editor panel includes a primary editor sub-panel for editing content of the primary document and a secondary editor sub-panel for editing content of the secondary files.

14. The computer-readable storage medium of claim 13, wherein the content of the primary document and the content of at least one of the secondary files are displayed at the same time by the code editor panel.

15. The computer-readable storage medium of claim 13, wherein the code editor panel is configured to be used to edit the content of the primary document and the content of at least one of the secondary files at the same time.

16. The computer-readable storage medium of claim 13, wherein the primary document is an HTML document.

17. The computer-readable storage medium of claim 13, and further comprising:
providing categorized access to the secondary files via the secondary editor sub-panel, including access to Cascading Style Sheet (CSS) files related to the primary document, JavaScript files related to the primary document, and HTML files related to the primary document.

18. The computer-readable storage medium of claim 17, wherein selection of one of the secondary files causes content of the selected file to be displayed in the secondary editor sub-panel.

19. The computer-readable storage medium of claim 13, and further comprising:
generating as part of the user interface at least one visual design tool for providing a design view of the application; and
automatically highlighting content in the secondary editor sub-panel based on a change made with the at least one visual design tool.

20. A method comprising:
providing a Web development tool for developing an application that includes a primary document and a plurality of related files;
generating a user interface for controlling the Web development tool;
generating as part of the user interface a code editor panel, wherein the code editor panel includes a primary editor sub-panel for editing content of the primary document and a secondary editor sub-panel for editing content of the related files; and
wherein the code editor panel is configured to be used to simultaneously edit the content of the primary document and the content of at least one of the related files, and wherein the generating a user interface and the generating as part of the user interface a code editor panel are performed by at least one processor.
